(19) United States
(12) Patent Application Publication
(10) Pub. No.: US 2024/0356374 A1
(43) Pub. Date: Oct. 24, 2024

(54) MULTIFUNCTIONAL CHARGING CIRCUIT, ELECTRIC DEVICE, AND CHARGING SYSTEM

(71) Applicant: The Hong Kong Polytechnic University, Hong Kong (CN)

(72) Inventors: Chi Shing WONG, Hong Kong (CN); Ka Hong LOO, Hong Kong (CN); Junwei LIU, Hong Kong (CN)

(21) Appl. No.: 18/640,220

(22) Filed: Apr. 19, 2024

(30) Foreign Application Priority Data
Apr. 19, 2023 (CN) 202310419857.6

(51) Int. Cl. H02J 50/12; H02J 7/06

(52) U.S. Cl. CPC H02J 50/12; H02J 7/06; H02J 2207/20

(57) ABSTRACT

A multifunctional charging circuit includes: a first inverter circuit connected to a primary side winding of an isolation transformer and configured to convert a received first direct current into a first alternating current, then outputting it to the primary side winding; a first wireless charging coil, with one end connected to a corresponding end of a secondary side winding of the isolation transformer, and designed to receive electrical power wirelessly transmitted by a second wireless charging coil; a first resonance compensation circuit connected to the other end of the first wireless charging coil and the corresponding end of the secondary side winding, and configured to generate a resonance based on the electrical power received by the first wireless charging coil and/or the first alternating current received by the secondary side winding, subsequently outputting a first charging current to the rectifier circuit.

### CROSS-REFERENCE TO RELATED APPLICATION

The present application claims the priority of a Chinese Patent Application, with application No. 202310419857.6, filed on Apr. 19, 2023; the contents of which are hereby incorporated by reference into the present application.

### TECHNICAL FIELD

The present application pertains to the technical field of charging and, more specifically, to a multifunctional charging circuit, an electric device, and a charging system.

### BACKGROUND

Currently, the charging methods for electric devices (such as electric vehicles, bicycles, and robots) include wired and wireless charging. Wired charging holds a dominant position in the field due to its high efficiency and rapid charging capabilities. Meanwhile, wireless charging is garnering increasing attention for its convenience, safety, and the absence of sparks and electric shock risks. Given the swift advancement of wireless charging technology and the distinct advantages of both wireless and wired charging, future charging stations are expected to offer both services. Consequently, some electric device manufacturers have proposed an integrated charging system that combines the receiver circuits for both wireless and wired charging within the same electric device, enabling the device to support both charging modes simultaneously.

However, the mere integration of the receiver circuits for wireless and wired charging into the electric device can lead to an increase in redundant circuit components, resulting in lower device utilization, higher manufacturing costs, increased space requirements, and reduced power density.

### SUMMARY

The present application introduces a multifunctional charging circuit, an electric device, and a charging system that aim to resolve the issues associated with the excessive number of redundant circuit components in traditional charging circuits, which lead to lower device utilization, higher manufacturing costs, increased space occupancy, and lower power density.

A first aspect of an embodiment of the present application provides a multifunctional charging circuit, which includes: a first inverter circuit, an isolation transformer, a first wireless charging coil, a first resonance compensation circuit, and a rectifier circuit.

The first inverter circuit is connected to the primary side winding of the isolation transformer and is configured to convert a received direct current into an alternating current, which is then supplied to the primary side winding.

The first end of the first wireless charging coil is connected to the first end of the secondary side winding of the isolation transformer, and the coil is designed to receive electrical power wirelessly transmitted by a second wireless charging coil.

The first resonance compensation circuit is connected to the second end of the first wireless charging coil and the second end of the secondary side winding. It is configured to generate resonance based on the electrical power received by the first wireless charging coil and/or the alternating current received by the secondary side winding, and to output a charging current to the rectifier circuit.

The rectifier circuit is designed to rectify the charging current and to supply the rectified current to an energy storage module.

Optionally, the first resonance compensation circuit includes a first capacitor, a second capacitor, and a first inductor.

The first end of the first capacitor is connected to the second end of the first wireless charging coil, the second end of the first capacitor is connected to the first end of the second capacitor and the first end of the first inductor, and the second end of the second capacitor is connected to the second end of the secondary side winding.

The second end of the first inductor and the second end of the second capacitor are connected to the rectifier circuit to facilitate the output of the charging current.

Optionally, when the multifunctional charging circuit operates in wired charging mode, the phase of the voltage output by the rectifier circuit lags 90° behind the phase of the voltage output by the first inverter circuit.

Optionally, the rectifier circuit is further configured to convert electrical power stored in the energy storage module into a third alternating current, and the first resonance compensation circuit is further configured to generate resonance based on the third alternating current and to output a discharging current to the first wireless charging coil and/or the secondary side winding.

Optionally, when the multifunctional charging circuit operates in wired discharging mode, the phase of the voltage of the third alternating current output by the rectifier circuit leads the phase of the voltage of the primary side winding by 90°.

When the multifunctional charging circuit operates in wireless discharging mode, the phase of the voltage of the third alternating current output by the rectifier circuit leads the phase of the voltage of the first wireless charging coil by 90°.

When the multifunctional charging circuit operates in mixed discharging mode, the phase of the voltage of the third alternating current output by the rectifier circuit leads the phase of the voltage of the primary side winding by 90°, and also leads the phase of the voltage of the first wireless charging coil by 90°.

A second aspect of an embodiment of the present application provides an electric device that includes the multifunctional charging circuit and the energy storage module described in the first aspect, with the multifunctional charging circuit configured to charge the energy storage module.

Optionally, the multifunctional charging circuit is further configured to release the electrical power stored in the energy storage module.

A third aspect of an embodiment of the present application provides a charging system that includes a wireless charging circuit and the multifunctional charging circuit described in the first aspect.

The wireless charging circuit includes a second wireless charging coil designed to wirelessly transmit electrical power to the first wireless charging coil in the multifunctional charging circuit.

Optionally, the wireless charging circuit includes a second resonance compensation circuit, with the structure of this circuit and that of the first resonance compensation circuit in the multifunctional charging circuit arranged symmetrically.

Optionally, the wireless charging circuit also includes a second inverter circuit.

The second inverter circuit is configured to convert a received second direct current into a second alternating current and to supply this current to the second resonance compensation circuit.

The second resonance compensation circuit is connected to the second inverter circuit to generate resonance based on the second alternating current and to output electrical power to the second wireless charging coil.

Optionally, when the charging system operates in wireless charging mode, the phase of the voltage output by the rectifier circuit lags 90° behind the phase of the induced voltage of the first wireless charging coil.

When the charging system operates in mixed charging mode, the phase of the voltage output by the rectifier circuit lags 90° behind both the phase of the voltage output by the first inverter circuit and the phase of the induced voltage of the first wireless charging coil.

Optionally, the rectifier circuit is further configured to convert electrical power stored in the energy storage module into a third alternating current, and the first resonance compensation circuit is further configured to generate resonance based on the third alternating current and to output a discharging current to the first wireless charging coil and/or the secondary side winding.

Optionally, when the charging system operates in wired discharging mode, the phase of the voltage of the third alternating current output by the rectifier circuit leads the phase of the voltage of the primary side winding by 90°.

When the charging system operates in wireless discharging mode, the phase of the voltage of the third alternating current output by the rectifier circuit leads the phase of the voltage of the first wireless charging coil by 90°.

When the charging system operates in mixed discharging mode, the phase of the voltage of the third alternating current output by the rectifier circuit leads the phase of the voltage of the primary side winding by 90°, and also leads the phase of the voltage of the first wireless charging coil by 90°.

Optionally, when the charging system operates in wired charging mode, the second wireless charging coil is configured to stop the wireless transmission of electrical power; and/or when the charging system operates in wireless charging mode, either the primary side winding is in a short-circuit state or the secondary side winding is in a short-circuit state.

The beneficial effects of the embodiment of the present application, compared to prior art, are as follows:

The first wireless charging coil is positioned between the secondary side winding and the first resonance compensation circuit, with the first charging current being output through the first resonance compensation circuit. This circuit can compensate for the reactive power introduced by both the second and first wireless charging coils, allowing the wired and wireless charging modes to share the first resonance compensation circuit and the rectifier circuit. This not only saves on traditional circuit components that would otherwise be used in conjunction with the first wireless charging coil, improving device utilization, reducing manufacturing costs, and decreasing space occupation, but it also retains the traditional isolation transformer to maintain the efficiency of conventional wired charging, thereby enhancing the power density of the charging circuit.

### BRIEF DESCRIPTION OF THE DRAWINGS

FIG. 1 is a structural schematic diagram of an integrated charging system provided by related technologies.

FIG. 2 is a structural schematic diagram of a multifunctional charging circuit provided in an embodiment of the present application.

FIG. 3 is a structural schematic diagram of a charging system provided in an embodiment of the present application.

FIG. 4 is a circuit schematic diagram of a charging system provided in an embodiment of the present application.

FIG. 5 is an equivalent circuit diagram of a charging system provided in an embodiment of the present application.

FIG. 6 is an operating waveform of a charging system provided in an embodiment of the present application, which considers only a fundamental component.

FIG. 7 is a vector diagram of a charging system provided in an embodiment of the present application.

FIG. 8 is another schematic diagram of a charging system provided in an embodiment of the present application.

FIG. 9 is a structural schematic diagram of an electric device provided in an embodiment of the present application.

### DETAILED DESCRIPTION OF EMBODIMENTS

To clarify the objectives, technical solutions, and advantages of the present application, it will be further described in detail below with reference to the accompanying figures and embodiments. It should be understood that the specific embodiments described herein are intended solely to illustrate the present application and not to limit its scope.

It is noted that when a component is referred to as being “fixed to” or “disposed on” another component, it can be directly on or indirectly associated with the other component. When a component is referred to as being “connected to” another component, it can be directly connected to or indirectly interfaced with the other component.

Furthermore, the terms “first” and “second” are used for descriptive purposes only and should not be construed as indicating or implying any relative importance or implicitly specifying the quantity of the indicated technical features. Thus, the feature(s) defined by “first” or “second” may include one or more of such features. In the description of the present invention, “a plurality of” means two or more unless explicitly and specifically defined otherwise.

The charging methods for electric devices include wired charging and wireless charging. Wired charging is predominant in the field due to its high efficiency and fast charging speeds. Wireless charging is increasingly recognized for its convenience, safety, and the elimination of sparks and electric shock risks. Considering the rapid advancement of wireless charging technology and the respective advantages of both wireless and wired charging, future charging stations are anticipated to provide both services. Therefore, some electric device manufacturers have proposed an integrated charging system that combines the receiver circuits of both the wireless and wired charging systems within the same electric device, enabling the device to support both wired and wireless charging simultaneously.

For example, FIG. 1 illustrates an integrated charging system provided by related technologies. The electric device side includes both a wired charging circuit and a receiver circuit for a wireless charging system, while the charging station side features a transmitting circuit for the wireless charging system.

As an example, the two alternating currents shown in FIG. 1 can originate from the same power source or different power sources; the structures of the two power factor correction circuits can be identical or different; the structures of the two inverter circuits can be identical or different; the structures of the three resonance networks can be identical or different. The structures of the two rectifier circuits can be identical or different; the structures of the two batteries can be identical or different, which is not limited in the embodiments of the present application.

The working principle of the wired charging circuit is as follows: the alternating current passes through the power factor correction circuit, the inverter circuit, the resonance network, the isolation transformer, and the rectifier circuit to charge the battery. The working principle of the wireless charging circuit is as follows: AC passes through the power factor correction circuit, the inverter circuit, the resonance network, the wireless charging transmitting coil, the wireless charging receiving coil, the resonance network, and the rectifier circuit to charge the battery.

As can be seen from the above, the integrated charging system provided by related technologies simply combines the receiver circuits of the wireless and wired charging systems within the electric device, resulting in a large number of redundant circuit components, lower device utilization, higher manufacturing costs, increased space requirements, and lower power density.

In response to this, the embodiment of the present application provides a multifunctional charging circuit, an electric device, and a charging system that integrate a wireless charging receiver coil into the multifunctional charging circuit. The rectifier circuit is shared by the wireless charging system and the multifunctional charging circuit without requiring additional components. This approach can save on traditional circuit devices (such as the resonance network in the wired charging circuit and the rectifier circuit in the wireless charging system, as shown in FIG. 1) that would otherwise be used to match the wireless charging receiver coil. Consequently, this improves device utilization, reduces manufacturing costs, and decreases space requirements, while also retaining the traditional isolation transformer to maintain the efficiency of conventional wired charging. Thus, the power density of the charging circuit is enhanced.

To illustrate the technical solution described in this application, the following is explained through specific embodiments.

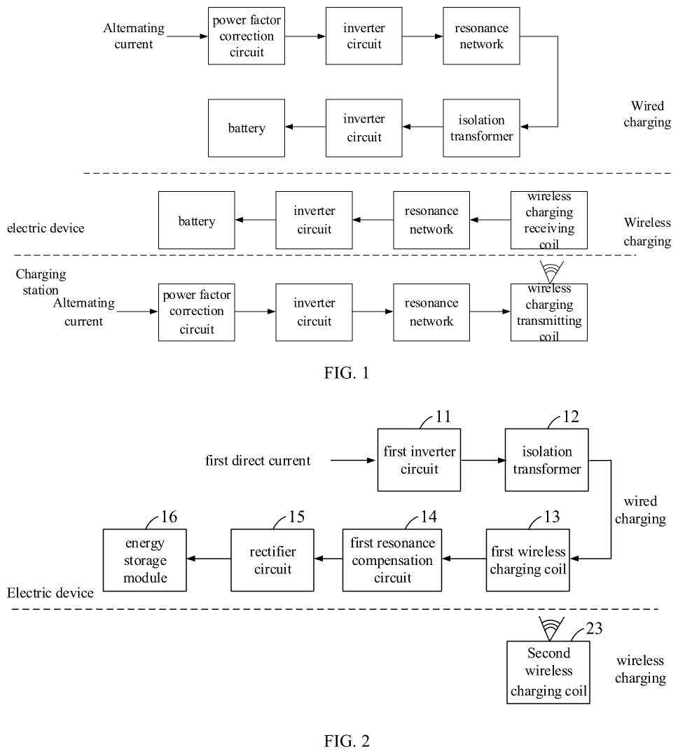

FIG. 2 is a structural schematic diagram of a multifunctional charging circuit provided by an embodiment of this application. For simplicity, only the components relevant to the embodiment are shown.

As depicted in FIG. 2, the multifunctional charging circuit in the embodiment includes a first inverter circuit 11, an isolation transformer 12, a first wireless charging coil 13, a first resonance compensation circuit 14, and a rectifier circuit 15.

The first inverter circuit 11 is connected to the primary side winding of the isolation transformer 12 (not illustrated in the figure) and is designed to convert the received direct current into an alternating current, subsequently outputting this alternating current to the primary side winding. The first end of the first wireless charging coil 13 is connected to the first end of the secondary side winding of the isolation transformer 12 (not illustrated in the figure), and the first wireless charging coil 13 is tasked with receiving the electrical power transmitted wirelessly by the second wireless charging coil 23. The first resonance compensation circuit 14 is connected to the second end of the first wireless charging coil 13 and the second end of the secondary side winding. It is responsible for generating a resonance based on the electrical power received by the first wireless charging coil 13 and/or the alternating current received by the secondary side winding, and for outputting the first charging current to the rectifier circuit 15. The rectifier circuit 15 is designed to rectify the first charging current and to supply the rectified current to the energy storage module 16.

In essence, the multifunctional charging circuit in the embodiment can operate in wired charging mode, where the first resonance compensation circuit 14 generates resonance based on the alternating current received by the secondary side winding and outputs the first charging current to the rectifier circuit 15. It can also function in wireless charging mode, where the first resonance compensation circuit 14 generates resonance based on the electrical power received by the first wireless charging coil 13 and outputs the first charging current to the rectifier circuit 15. Additionally, it can operate in mixed charging mode, simultaneously working in both wired and wireless charging modes. In this scenario, the first resonance compensation circuit 14 generates resonance based on both the electrical power received by the first wireless charging coil 13 and the alternating current received by the secondary side winding, and outputs the first charging current to the rectifier circuit 15.

Therefore, the multifunctionality of the charging circuit provided in the embodiment refers to its capability to support both wired and wireless charging functions, as well as a mixed charging function that combines both.

It should be noted that since the principle of wireless charging is based on inductive charging, the receiving circuit operates inductively, meaning the second wireless charging coil 23 and the first wireless charging coil 13 introduce reactive power. Another role of the first resonance compensation circuit 14 is to compensate for the reactive power introduced by both the second and first wireless charging coils 23 and 13 during resonance.

The embodiment of this application does not limit the type of the energy storage module 16. Optionally, in this application, the energy storage module 16 is considered to be a rechargeable battery.

This application does not specify the location of the second wireless charging coil 23 nor the method of wirelessly transmitting electrical power. For instance, the second wireless charging coil 23 could be located in a charging station (including both domestic and commercial charging stations). These charging stations can also be referred to as charging piles or commercial charging devices.

The operating principle of the multifunctional charging circuit in this embodiment is as follows:

In wired charging mode, the second wireless charging coil 23 does not transmit electrical power, and the voltage of the first wireless charging coil 13 is zero. The direct current is converted into an alternating current by the first inverter circuit 11, and this alternating current is fed into the primary side winding of the isolation transformer 12. The voltage from the secondary side winding is then passed through the first wireless charging coil 13 to the first resonance compensation circuit 14, generating a stable first charging current. This current is rectified by the rectifier circuit 15 to charge the energy storage module 16.

In wireless charging mode, the isolation transformer 12 does not output electrical power, and the voltage of the secondary side winding is zero. The second wireless charging coil 23 wirelessly transmits electrical power to the first wireless charging coil 13, inducing a voltage. This induced voltage is fed into the first resonance compensation circuit 14 to generate a stable first charging current, which is rectified by the rectifier circuit 15 to charge the energy storage module 16.

In mixed charging mode, both the voltage of the first wireless charging coil 13 and the voltage of the secondary side winding are input into the first resonance compensation circuit 14 to generate a stable first charging current. This current is rectified by the rectifier circuit 15 to charge the energy storage module 16.

From the above working principle, it is evident that the multifunctional charging circuit provided by the embodiment offers the following advantages:
(1) The first wireless charging coil 13 is positioned between the secondary side winding and the first resonance compensation circuit 14, with the first charging current being output through the first resonance compensation circuit 14. This circuit can compensate for the reactive power introduced by both the second wireless charging coil 23 and the first wireless charging coil 13, allowing the wired and wireless charging modes to share the first resonance compensation circuit 14 and the rectifier circuit 15. This arrangement saves traditional circuit components that would otherwise be required for the first wireless charging coil 13 (i.e., the wireless charging receiving coil), thereby improving device utilization, reducing manufacturing costs, and decreasing space requirements, which in turn enhances the power density of the charging circuit.
(2) The traditional isolation transformer 12 is retained to preserve the charging efficiency of conventional wired charging.
(3) The multifunctional charging circuit can operate in mixed charging mode, increasing output power to enhance device utilization and charging efficiency.

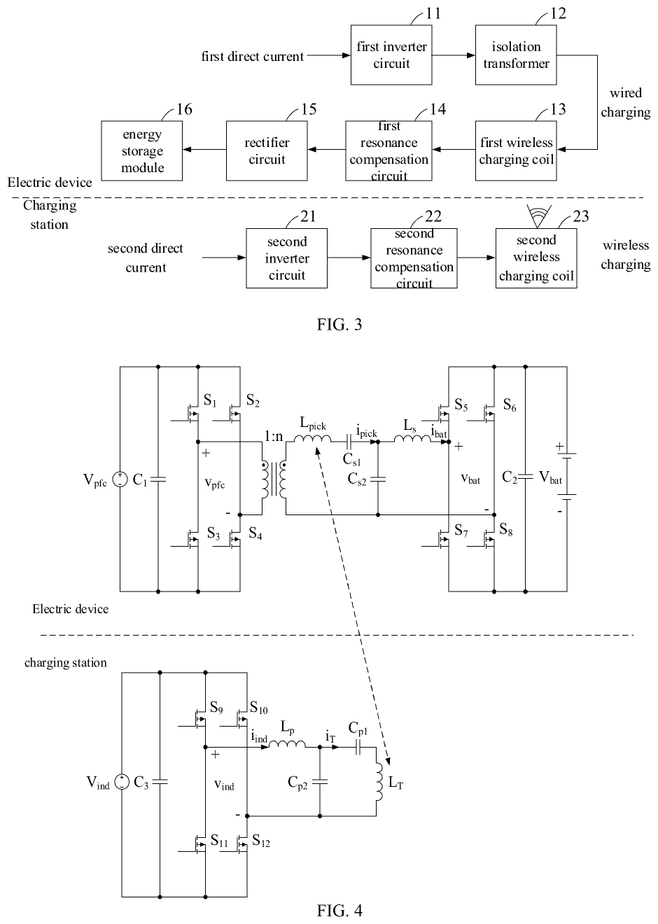

As illustrated in FIG. 3, the above multifunctional charging circuit can be applied to a charging system. The charging station side also includes a second inverter circuit 21 and a second resonance compensation circuit 22.

The second inverter circuit 21 is designed to convert the received second direct current into a second alternating current and to output this second alternating current to the second resonance compensation circuit 22. The second resonance compensation circuit 22, connected to the second inverter circuit 21, generates resonance based on the second alternating current and outputs electrical power to the second wireless charging coil 23, compensating for the reactive power introduced by both the second and first wireless charging coils 23 and 13.

Optionally, the first and second direct currents can originate from the same power source or from separate power sources; the configurations of the second inverter circuit 21 and the first inverter circuit 11 can be identical or different; the designs of the first resonance compensation circuit 14 and the second resonance compensation circuit 22 can be identical or different, which are not restricted in the embodiment.

The embodiments of this application do not limit the configurations of the first inverter circuit 11, the isolation transformer 12, the first wireless charging coil 13, the first resonance compensation circuit 14, the rectifier circuit 15, the second inverter circuit 21, the second resonance compensation circuit 22, and the second wireless charging coil 23, which can be adapted as needed.

As shown in FIG. 4, for example, the first inverter circuit 11 comprises a first switching transistor S₁, a second switching transistor S₂, a third switching transistor S₃, and a fourth switching transistor S₄. These transistors form a full-bridge inverter, with the input end of the full-bridge inverter receiving the first direct current V_{pfc}. Optionally, the input end of the full-bridge inverter is also connected to a first filter capacitor C₁. The output end of the full-bridge inverter is connected to the primary side winding of the isolation transformer. For instance, the first switching transistor S₁ and the third switching transistor S₃ form the first bridge arm of the full-bridge inverter, while the second switching transistor S₂ and the fourth switching transistor S₄ form the second bridge arm, with the midpoints of both bridge arms connected to the ends of the primary side winding of the isolation transformer. In this example, the first direct current V_{pfc} can be converted to the first alternating current V_{pfc} by controlling the duty cycle of the first, second, third, and fourth switching transistors S₁, S₂, S₃, and S₄.

As an example, the rectifier circuit 15 includes a fifth switching transistor S₅, a sixth switching transistor S₆, a seventh switching transistor S₇, and an eighth switching transistor S₈. These transistors form a full-bridge rectifier, with the input end connected to the first resonance compensation circuit 14 and the output end connected to the energy storage module 16. Optionally, the output end of the full-bridge rectifier is further connected to a second filter circuit C₂. For example, the fifth switching transistor S₅ and the seventh switching transistor S₇ form the third bridge arm of the full-bridge rectifier, while the sixth switching transistor S₆ and the eighth switching transistor S₈ form the fourth bridge arm, with the midpoints of both bridge arms connected to the first resonance compensation circuit 14. In this example, rectification can be achieved through the intrinsic diodes in the fifth, sixth, seventh, and eighth switching transistors S₅, S₆, S₇, and S₈.

As an example, the second inverter circuit 21 comprises a ninth switching transistor S₉, a tenth switching transistor S₁₀, an eleventh switching transistor S₁₁, and a twelfth switching transistor S₁₂. These transistors form a full-bridge inverter, with the input end receiving the second direct current V_{ind}, and the output end connected to the second resonance compensation circuit 22. Optionally, a third filter capacitor C₃ is further connected to the input end of the full-bridge inverter. For instance, the ninth switching transistor S₉ and the eleventh switching transistor Su form the fifth bridge arm of the full-bridge inverter, while the tenth switching transistor S₁₀ and the twelfth switching transistor S₁₂ form the sixth bridge arm, with the midpoints of both bridge arms connected to the second resonance compensation circuit 22. In this example, the second direct current V_{ind} can be converted to the second alternating current V_{ind} by controlling the duty cycle of the ninth, tenth, eleventh, and twelfth switching transistors S₉, S₁₀, S₁₁, and S₁₂.

As an example, the first resonance compensation circuit 14 includes a first capacitor Cₛ₁, a second capacitor Cₛ₂, and a first inductor Lₛ. Optionally, the first capacitor Cₛ₁, the second capacitor Cₛ₂, and the first inductor Lₛ form an LCC compensation network.

The inductance of the first wireless charging coil 13 is L_{pick}. The first end of the first capacitor Cₛ₁ is connected to the second end of the inductor L_{pick}, the second end of the first capacitor Cₛ₁ is connected to the first end of the second capacitor Cₛ₂ and the first end of the first inductor Lₛ, and the second end of the second capacitor Cₛ₂ is connected to the second end of the secondary side winding. The second end of the first inductor Ls is connected to the midpoint of the third bridge arm, and the second end of the second capacitor Cₛ₂ is connected to the midpoint of the fourth bridge arm, facilitating the output of the first charging current to the rectifier circuit 15.

As an example, the second resonance compensation circuit 22 includes a second inductor Lₚ, a third capacitor Cₚ₁, and a fourth capacitor Cₚ₂. Optionally, the second inductor Lₚ, the third capacitor Cₚ₁, and the fourth capacitor Cₚ₂ form an LCC compensation network. Optionally, the first resonance compensation circuit 14 and the second resonance compensation circuit 22 form a dual-sided LCC compensation network.

The inductance of the second wireless charging coil 23 is LT. The second end of the second inductor Lₚ is connected to the first end of the third capacitor Cₚ₁ and the first end of the fourth capacitor Cₚ₂, the second end of the third capacitor Cₚ₁ is connected to the first end of the inductor L_{T}, and the second end of the fourth capacitor Cₚ₂ is connected to the second end of the inductor L_{T}. The first end of the second inductor Lₚ is connected to the midpoint of the fifth bridge arm, and the second end of the fourth capacitor Cₚ₂ is connected to the midpoint of the sixth bridge arm to receive the second alternating current V_{ind}.

Taking the charging system shown in FIG. 4 as an example, the Zero Voltage Switching (ZVS) and constant charging current characteristics of the switching transistors in the charging system are analyzed and explained below.

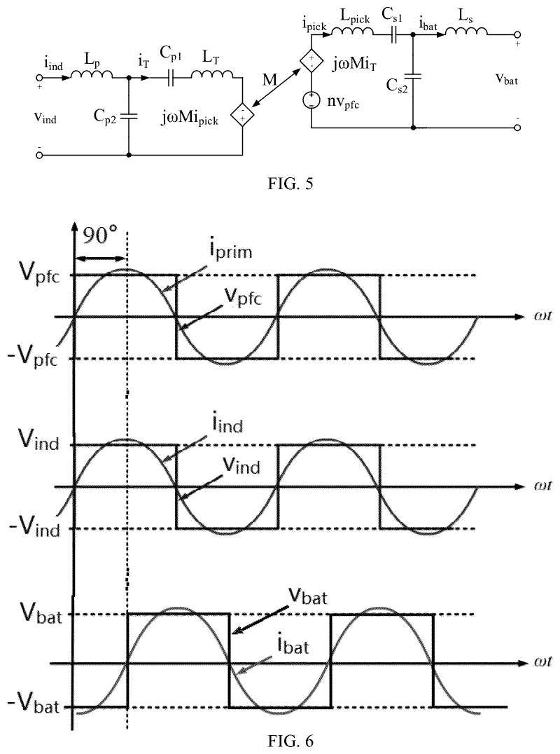

As an example, FIG. 5 is the equivalent circuit diagram of the circuit shown in FIG. 4. The Z-parameter matrix of the charging system is given by the following equations (1) and (2), and FIG. 6 shows the operating waveform of the charging system considering only the fundamental wave component. The following explains how the different charging modes operate.

$$[ \begin{matrix}{nV}_{pfc} + j ω {MI}_{T} \\ {V}_{bat}\end{matrix} ] = [ \begin{matrix}{Z}_{{L}_{pick}} + {Z}_{{C}_{s 1}} + {Z}_{{C}_{s 2}} & - {Z}_{{C}_{s 2}} \\ {Z}_{{C}_{s 2}} & - ( {Z}_{{C}_{s 2}} + {Z}_{{L}_{s}} )\end{matrix} ] [ \begin{matrix}{I}_{pick} \\ {I}_{bat}\end{matrix} ] \qquad ( 1 )$$

$${Z}_{{L}_{s}} = j ω {L}_{s} ,$$

$${Z}_{{L}_{pick}} = j ω {L}_{pick} ,$$

$${Z}_{{C}_{s 1}} = 1 / j ω {C}_{s 1} ,$$

$${Z}_{{C}_{s 2}} = 1 / j ω {C}_{s 2}$$

$$[ \begin{matrix}{V}_{ind} \\ j ω {MI}_{pick}\end{matrix} ] = [ \begin{matrix}{Z}_{{L}_{p}} + {Z}_{{C}_{p 2}} & - {Z}_{{C}_{p 2}} \\ {Z}_{{C}_{p 2}} & - ( {Z}_{{C}_{p 1}} + {Z}_{{C}_{p 2}} + {Z}_{{L}_{T}} )\end{matrix} ] [ \begin{matrix}{I}_{ind} \\ {I}_{T}\end{matrix} ] \qquad ( 2 )$$

$${Z}_{{L}_{p}} = j ω {L}_{p} ,$$

$${Z}_{{L}_{T}} = j ω {L}_{T} ,$$

$${Z}_{{L}_{p}} = j ω {L}_{p} ,$$

$${Z}_{{L}_{T}} = j ω {L}_{T} ,$$

In the case where the charging system operates in wired charging mode, the wireless charging circuit is inactive, and the induced voltage of the inductor L_{pick} is zero, that is, jωMi_{T}=0. The first direct current V_{pfc} provides electrical power to the first resonance compensation circuit 14. Equation (3) below represents the resonance condition of the first resonance compensation circuit 14.

$$ω {L}_{pick} - \frac{1}{ω {C}_{s 1}} = \frac{1}{ω {C}_{s 2}} = ω {L}_{s} \qquad ( 3 )$$

In reference to equation (1), under the resonance conditions, Z_{L}_{_{pick}}/+Z_{C}_{ₛ₁}+Z_{C}_{ₛ₂}=0 and Z_{C}_{ₛ₂}+Z_{L}_{ₛ}=0, the phasor of the charging current I_{bat} is given by equation (4) below, hence it is independent of the voltage V_{bat} and is solely a function of V_{pfc}.

$${I}_{bat} = \frac{n \vert {V}_{pfc} \vert ∠0}{j ω {L}_{s}} = \frac{n \vert {V}_{pfc} \vert}{ω {L}_{s}} ∠ - 90 ° \qquad ( 4 )$$

Similarly, the phasor of the current I_{pick} of the inductor L_{pick} is given by equation (5) below and is solely a function of V_{bat}. In other words, the current at one port is completely determined by the voltage at the other port.

$${I}_{pick} = \frac{- \vert {V}_{bat} \vert {∠θ}_{bat}}{j ω {L}_{s}} = \frac{\vert {V}_{bat} \vert}{ω {L}_{s}} ∠ {θ}_{bat} + 90 ° \qquad ( 5 )$$

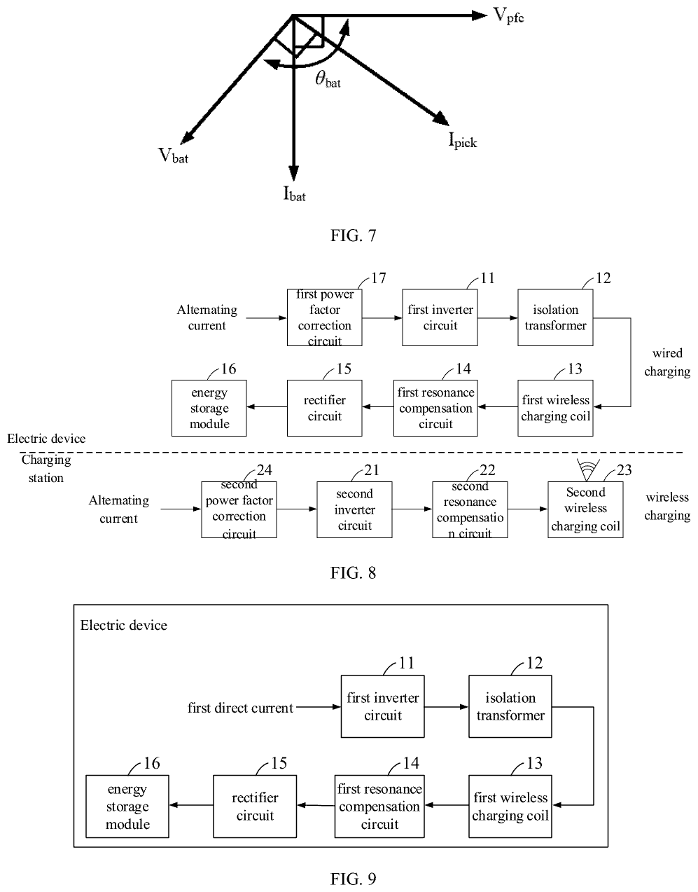

FIG. 7 shows the vector diagram of the charging system provided by the embodiment, from which it can be seen that V_{pfc} is always orthogonal to I_{bat}, and V_{bat} is orthogonal to I_{pick}.

Thus, when V_{bat} lags 90° behind v_{pfc} (i.e., θ_{bat}=−90°), v_{pfc} is in phase with i_{pick}, and v_{bat} is in phase with i_{bat}, which results in reduced reactive power and wired charging losses.

Optionally, in practice, v_{bat} can be controlled to lag slightly more than 90° behind v_{pfc} to facilitate the ZVS function of switching transistors S₁-S₄ and S₅-S₈.

Optionally, in wired charging mode, the power provided by the charging system can be calculated using equation (6) below.

$${P}_{cond} = \frac{1}{2} Re \{ {V}_{bat} {I}_{bat}^{*} \} = - \frac{8 {nV}_{pfc} {V}_{bat} sin {θ}_{bat}}{{π}^{2} ω {L}_{s}} \qquad ( 6 )$$

In the case where the charging system operates in wireless charging mode, the multifunctional charging circuit is inactive. For example, the primary side winding can be short-circuited by controlling the activation of the first switching transistor S₁ and the second switching transistor S₂ (or the activation of the third switching transistor S₃ and the fourth switching transistor S₄), or the secondary side winding can be short-circuited by a relay (not shown in the figure), rendering the multifunctional charging circuit inactive. Equation (7) is the resonance condition of the second resonance compensation circuit 22. Under this condition, referring to the Z-parameter matrix in equation (2), the inductor L_{T} is excited by the constant current i_{T} given by equation (8) below.

$$ω {L}_{T} - \frac{1}{ω {C}_{p 1}} = \frac{1}{ω {C}_{p 2}} = ω {L}_{p} \qquad ( 7 )$$

$${I}_{T} = \frac{\vert {V}_{ind} \vert ∠0}{j ω {L}_{p}} \qquad ( 8 )$$

The phasor of the current I_{bat} is determined by equation (9), and the current I_{ind} is given by equation (10) below.

By examining equations (9) and (10), it is found that when v_{bat} lags 90° behind v_{ind}, v_{ind} is in phase with i_{ind}, while v_{bat} is in phase with i_{bat}. Therefore, the wireless charging circuit can also achieve minimal charge loss and reactive power.

$${I}_{bat} = \frac{j ω {MI}_{T}}{j ω {L}_{s}} = \frac{M \vert {V}_{ind} \vert ∠0}{j ω {L}_{p} {L}_{s}} \qquad ( 9 )$$

$${I}_{ind} = \frac{- j ω {MI}_{pick}}{j ω {L}_{p}} = \frac{- M \vert {V}_{bat} \vert {∠0}_{bat}}{j ω {L}_{p} {L}_{s}} \qquad ( 10 )$$

It should be noted that, after analysis, it is found that in the embodiment of this application, when the phase of v_{bat} lags 90° behind the phase of the induced voltage jωMi_{T} of the inductor L_{pick}, the wireless charging circuit can also achieve minimal charge loss and reactive power.

Therefore, when the charging system operates in wireless charging mode or mixed charging mode, the phase of V_{bat} is controlled to lag 90° behind the phase of the induced voltage jωMi_{T} of the inductor L_{pick}. As an example, when the wireless charging circuit shown in FIG. 3 or FIG. 4 is used, v_{bat} is controlled to lag 90° behind v_{ind}, such that the phase of V_{bat} lags 90° behind the phase of the induced voltage jωMi_{T} of the inductor L_{pick}. Consequently, the wireless charging circuit can also achieve minimal charge loss and reactive power.

Optionally, in wireless charging mode, the power provided by the charging system can be calculated using equation (11) below.

$${P}_{ind} = - \frac{8 {MV}_{ind} {V}_{bat} sin {θ}_{bat}}{{π}^{2} ω {L}_{p} {L}_{s}} \qquad ( 11 )$$

In the case where the charging system operates in mixed charging mode, that is, when the multifunctional charging circuit and the wireless charging circuit work simultaneously, the total charging power of the charging system can be increased, thus reducing the charging time and improving charging efficiency.

For example, the phase of the induced voltage jωMi_{T} of the inductor L_{pick} and the phase of V_{pfc} are controlled to lead the phase of V_{bat} by 90°, allowing the multifunctional charging circuit and the wireless charging circuit to operate concurrently.

In other words, the present embodiment can decouple the power of wired and wireless charging through phase shift control, enabling the multifunctional charging circuit and the wireless charging circuit to work simultaneously to increase the total charging power of the charging system.

By substituting equation (8) into jωMi_{T}, it is found that the induced voltage jωMi_{T} caused by the wireless charging is in phase with V_{pfc}. Since jωMi_{T} is in phase with V_{pfc}, and i_{pick} depends only on the battery voltage as shown in equation (5), the power of the wireless charging circuit and the multifunctional charging circuit can be decoupled from each other. Therefore, the wireless charging circuit and the multifunctional charging circuit can supply power to the battery simultaneously, and the total power is the linear sum of the output powers of both circuits. That is, the total power is equal to the sum of equations (6) and (11), as specifically seen in equation (12) below.

$${P}_{sim} = {P}_{cond} + {P}_{ind} = - \frac{8 {V}_{bat} sin {θ}_{bat}}{{π}^{2} ω {L}_{s}} ( {nV}_{pfc} + \frac{{MV}_{ind}}{{L}_{p}} ) \qquad ( 12 )$$

It should be noted that regardless of whether the multifunctional charging circuit and the wireless charging circuit are operating simultaneously or independently, the rated currents of the multifunctional charging circuit and the wireless charging circuit remain unchanged. In other words, the rated currents of the first wireless charging coil 13 and the isolation transformer 12 remain constant.

Even when the charging system operates in mixed charging mode, the magnetic properties of the wireless charging circuit and the multifunctional charging circuit will not become saturated, and the primary sides of both circuits will still maintain their rated power operation. Therefore, the same magnetic properties and converter design can accommodate the three charging modes: wired charging, wireless charging, and mixed charging.

It should be noted that the multifunctional charging circuit provided by the embodiments shown in FIGS. 2 to 4 can also operate in discharging mode to achieve bidirectional transmission of electrical power. For example, the Vehicle-to-Grid (V2G) function can be implemented.

For instance, when the multifunctional charging circuit operates in discharging mode, the rectifier circuit 15 is further configured to convert the electrical power stored in the energy storage module 16 into a third alternating current. The first resonance compensation circuit 14 is further configured to generate resonance based on this third alternating current and to output the discharging current to the first wireless charging coil 13 and/or the secondary side winding.

For example, if the first resonance compensation circuit 14 generates resonance based on the third alternating current and outputs a discharging current to the first wireless charging coil 13, and the isolation transformer 12 is inactive, the multifunctional charging circuit operates in wireless discharging mode. The first wireless charging coil 13 transmits the electrical power to the second wireless charging coil 23, thereby releasing the electrical power stored by the energy storage module 16 through the second wireless charging coil 23. As an example, the second wireless charging coil 23 releases the electrical power through the second resonance compensation circuit 22 and the second inverter circuit 21.

For example, if the first resonance compensation circuit 14 generates resonance based on the third alternating current and outputs the discharging current to the secondary side winding, and the second wireless charging coil 23 is inactive, the multifunctional charging circuit operates in wired discharging mode. The secondary side winding transmits the electrical power to the primary side winding to release the electrical power stored in the energy storage module 16. As an example, the primary side winding releases the electrical power through the first inverter circuit 11.

For example, if the first resonance compensation circuit 14 generates resonance based on the third alternating current and outputs the discharging current to both the first wireless charging coil 13 and the secondary side winding, the multifunctional charging circuit operates in mixed discharging mode, that is, in both wired and wireless discharging modes. In mixed discharging mode, the first wireless charging coil 13 transmits the electrical power to the second wireless charging coil 23, and the secondary side winding transmits the electrical power to the primary side winding to release the electrical power stored in the energy storage module 16. As an example, the second wireless charging coil 23 releases the electrical power through the second resonance compensation circuit 22 and the second inverter circuit 21, and the primary side winding releases the electrical power through the first inverter circuit 11.

Based on the embodiments shown in FIGS. 2 to 7, as an example, the phase of the voltage of the third alternating current output by the rectifier circuit 15 leads the phase of the voltage of the primary side winding by 90° when the multifunctional charging circuit operates in wired discharging mode.

As an example, when the multifunctional charging circuit operates in wireless discharging mode, the phase of the voltage of the third alternating current output by the rectifier circuit leads the phase of the voltage of the first wireless charging coil 13 by 90°.

As an example, when the multifunctional charging circuit operates in mixed discharging mode, the phase of the voltage of the third alternating current output by the rectifier circuit leads the phase of the voltage of the primary side winding by 90°, and the phase of the voltage of the third alternating current output by the rectifier circuit 15 also leads the phase of the voltage of the first wireless charging coil 13 by 90°.

As shown in FIG. 8, as an example, the multifunctional charging circuit provided by the embodiment further includes a first power factor correction circuit 17, which is connected to the first inverter circuit 11 to convert the received alternating current into the first direct current V_{pfc}, thereby improving the power factor of the alternating current.

As an example, the second inverter circuit 21 is also connected to a second power factor correction circuit 24, which receives alternating current and converts it into the second direct current V_{ind}.

Optionally, the configurations of the first power factor correction circuit 17 and the second power factor correction circuit 24 can be identical or different; the alternating currents connected to the first power factor correction circuit 17 and the second power factor correction circuit 24 can come from the same power source or from different power sources, which are not restricted in the embodiment.

In summary, the multifunctional charging circuit provided in the embodiment can operate in wired charging mode, wireless charging mode, or mixed charging mode to achieve faster charging speeds. By incorporating the first wireless charging coil 13 of a wireless charging circuit into a multifunctional charging circuit, the number of circuit devices and manufacturing costs can be significantly reduced. Additionally, the tightly coupled isolation transformer is retained in the charging system, which can maintain the efficiency of traditional wired charging. Due to the nature of the first resonance compensation circuit 14 and the second resonance compensation circuit 22, the power of the wireless charging circuit and the multifunctional charging circuit can be easily decoupled by simple phase shift control, enabling mixed charging mode. The multifunctional charging circuit provided in the embodiment can further operate in wired discharging mode, wireless discharging mode, or mixed discharging mode to achieve bidirectional transmission of electrical power.

As shown in FIG. 9, another embodiment of this application further includes an electric device comprising a multifunctional charging circuit provided by any of the above embodiments and an energy storage module 16. For example, the electric device includes the multifunctional charging circuit and the energy storage module 16 as shown in FIG. 2. Optionally, the multifunctional charging circuit is configured to charge the energy storage module, which is used to provide the electrical power required for the operation of the electric device.

Optionally, the multifunctional charging circuit is further configured to release the electrical power stored in the energy storage module 16.

For example, the electric device could be an electric vehicle (or an electric bicycle), with the energy storage module 16 being a rechargeable battery that provides electricity for driving the vehicle (or bicycle). Optionally, the rechargeable battery can also release electrical power through the multifunctional charging circuit.

For example, if the electric device is an electric robot, the energy storage module 16 is a rechargeable battery that provides electricity for the robot's movement. Optionally, the rechargeable battery can also release electrical power through the multifunctional charging circuit.

The electric device provided in the embodiment also benefits from the aforementioned advantages.

In another embodiment of this application, a charging system is provided, which includes a multifunctional charging circuit installed on an electric device and a wireless charging circuit located at a charging station.

As shown in FIG. 3, the multifunctional charging circuit includes a first inverter circuit 11, an isolation transformer 12, a first wireless charging coil 13, a first resonance compensation circuit 14, and a rectifier circuit 15. The first inverter circuit 11 is connected to the primary side winding of the isolation transformer 12 to convert the received direct current into the first alternating current and to output it to the primary side winding. The first end of the first wireless charging coil 13 is connected to the first end of the secondary side winding of the isolation transformer 12, and the first wireless charging coil 13 is used to receive the electrical power transmitted wirelessly by the second wireless charging coil 23. The first resonance compensation circuit 14 is connected to the second end of the first wireless charging coil 13 and the second end of the secondary side winding. It is used to output the first charging current to the rectifier circuit 15 based on the electrical power received by the first wireless charging coil 13 and/or the secondary side winding, and to compensate for the reactive power introduced by the second wireless charging coil 23 and the first wireless charging coil 13. The rectifier circuit 15 is used to rectify the first charging current and to output the rectified current to the energy storage module 16.

The wireless charging circuit includes a second inverter circuit 21, a second resonance compensation circuit 22, and a second wireless charging coil 23. The second inverter circuit 21 is used to convert the received second direct current into the second alternating current and to output it to the second resonance compensation circuit 22. The second resonance compensation circuit 22 is connected to the second inverter circuit 21 and is used to output electrical power to the second wireless charging coil 23 based on the second alternating current, and to compensate for the reactive power introduced by the second wireless charging coil 23 and the first wireless charging coil 13.

As an example, when the charging system operates in discharging mode, the rectifier circuit is further used to convert the electrical power stored in the energy storage module 16 into a third alternating current, and the first resonance compensation circuit 14 is further used to generate resonance based on the third alternating current and to output the discharging current to the first wireless charging coil 13 and/or the secondary side winding. Since the working principle of the discharging mode has been described above, it will not be repeated here.

As an example, when the charging system operates in wired discharging mode, the phase of the voltage of the third alternating current output by the rectifier circuit 15 leads the phase of the voltage of the primary side winding by 90°.

As an example, when the charging system operates in wireless discharging mode, the phase of the voltage of the third alternating current output by the rectifier circuit 15 leads the phase of the voltage of the first wireless charging coil 13 by 90°.

As an example, when the charging system operates in mixed discharging mode, the phase of the voltage of the third alternating current output by the rectifier circuit 15 leads the phase of the voltage of the primary side winding by 90°, and the phase of the voltage of the third alternating current output by the rectifier circuit 15 also leads the phase of the voltage of the first wireless charging coil 13 by 90°.

The charging system provided in the embodiment also benefits from the aforementioned advantages.

The above embodiments are used only to illustrate the technical solutions of this application and are not intended to limit it; notwithstanding the detailed description of this application by reference to the foregoing embodiments, it should be understood by those skilled in the art that they may modify the technical solutions recorded in the foregoing embodiments or make equivalent substitutions for some of the technical features; such modifications or substitutions shall not deviate from the essence of the corresponding technical solutions from the spirit and scope of the technical solutions of each embodiment of this application, and shall be included in the scope of protection of this application.

What is claimed is:

1. A multifunctional charging circuit, comprising:
a first inverter circuit, an isolation transformer, a first wireless charging coil, a first resonance compensation circuit, and a rectifier circuit;
wherein the first inverter circuit is connected to a primary side winding of the isolation transformer and configured to convert a received first direct current into a first alternating current and to output the first alternating current to the primary side winding;
wherein a first end of the first wireless charging coil is connected to a first end of a secondary side winding of the isolation transformer, and the first wireless charging coil is configured to receive electrical power wirelessly transmitted by a second wireless charging coil;
wherein the first resonance compensation circuit is connected to a second end of the first wireless charging coil and a second end of the secondary side winding, and is configured to generate a resonance based on the electrical power received by the first wireless charging coil and/or the first alternating current received by the secondary side winding, and to output a first charging current to the rectifier circuit; and
wherein the rectifier circuit is configured to rectify the first charging current and to output the rectified first charging current to an energy storage module.

2. The multifunctional charging circuit according to claim 1, wherein the first resonance compensation circuit comprises a first capacitor, a second capacitor, and a first inductor;
a first end of the first capacitor is connected to the second end of the first wireless charging coil, a second end of the first capacitor is connected to a first end of the second capacitor and a first end of the first inductor, and a second end of the second capacitor is connected to the second end of the secondary side winding; and
the second end of the first inductor and the second end of the second capacitor are connected to the rectifier circuit to output the first charging current to the rectifier circuit.

3. The multifunctional charging circuit according to claim 1, wherein when the multifunctional charging circuit is operated in a wired charging mode, a phase of a voltage output by the rectifier circuit is 90° behind a phase of a voltage output by the first inverter circuit.

4. The multifunctional charging circuit according to claim 2, wherein when the multifunctional charging circuit is operated in a wired charging mode, a phase of a voltage output by the rectifier circuit is 90° behind a phase of a voltage output by the first inverter circuit.

5. The multifunctional charging circuit according to claim 1, wherein the rectifier circuit is further configured to convert the electrical power stored in the energy storage module into a third alternating current, and the first resonance compensation circuit is further configured to generate a resonance based on the third alternating current and to output a discharging current to the first wireless charging coil and/or the secondary side winding.

6. The multifunctional charging circuit according to claim 2, wherein the rectifier circuit is further configured to convert the electrical power stored in the energy storage module into a third alternating current, and the first resonance compensation circuit is further configured to generate a resonance based on the third alternating current and to output a discharging current to the first wireless charging coil and/or the secondary side winding.

7. The multifunctional charging circuit according to claim 5, wherein when the multifunctional charging circuit is operated in a wired discharging mode, a phase of a voltage of the third alternating current output by the rectifier circuit is 90° ahead of a phase of a voltage of the primary side winding;
in a case when the multifunctional charging circuit is operated in a wireless discharging mode, the phase of the voltage of the third alternating current output by the rectifier circuit is 90° ahead of a phase of a voltage of the first wireless charging coil; and
in a case when the multifunctional charging circuit is operated in a mixed discharging mode, the phase of the voltage of the third alternating current output by the rectifier circuit is 90° ahead of the phase of the voltage of the primary side winding, and the phase of the voltage of the third alternating current output by the rectifier circuit is 90° ahead of the phase of the voltage of the first wireless charging coil.

8. An electric device, comprising a multifunctional charging circuit and an energy storage module, wherein the multifunctional charging circuit is configured to charge the energy storage module, and the multifunctional charging circuit comprises:
a first inverter circuit, an isolation transformer, a first wireless charging coil, a first resonance compensation circuit, and a rectifier circuit;
wherein the first inverter circuit is connected to a primary side winding of the isolation transformer and configured to convert a received first direct current into a first alternating current and to output the first alternating current to the primary side winding;
wherein a first end of the first wireless charging coil is connected to a first end of a secondary side winding of the isolation transformer, and the first wireless charging coil is configured to receive electrical power wirelessly transmitted by a second wireless charging coil;
wherein the first resonance compensation circuit is connected to a second end of the first wireless charging coil and a second end of the secondary side winding, and is configured to generate a resonance based on the electrical power received by the first wireless charging coil and/or the first alternating current received by the secondary side winding, and to output a first charging current to the rectifier circuit; and
wherein the rectifier circuit is configured to rectify the first charging current and to output the rectified first charging current to an energy storage module.

9. The electric device according to claim 8, wherein the multifunctional charging circuit is further configured to release the electrical power stored in the energy storage module.

10. The electric device according to claim 8, wherein the first resonance compensation circuit comprises a first capacitor, a second capacitor, and a first inductor;
a first end of the first capacitor is connected to the second end of the first wireless charging coil, a second end of the first capacitor is connected to a first end of the second capacitor and a first end of the first inductor, and a second end of the second capacitor is connected to the second end of the secondary side winding; and
the second end of the first inductor and the second end of the second capacitor are connected to the rectifier circuit to output the first charging current to the rectifier circuit.

11. The electric device according to claim 8, wherein when the multifunctional charging circuit is operated in a wired charging mode, a phase of a voltage output by the rectifier circuit is 90° behind a phase of a voltage output by the first inverter circuit.

12. The electric device according to claim 8, wherein the rectifier circuit is further configured to convert the electrical power stored in the energy storage module into a third alternating current, and the first resonance compensation circuit is further configured to generate a resonance based on the third alternating current and to output a discharging current to the first wireless charging coil and/or the secondary side winding.

13. A charging system, comprising a wireless charging circuit and a multifunctional charging circuit; wherein the multifunctional charging circuit comprises:
a first inverter circuit, an isolation transformer, a first wireless charging coil, a first resonance compensation circuit, and a rectifier circuit;
wherein the first inverter circuit is connected to a primary side winding of the isolation transformer and configured to convert a received first direct current into a first alternating current and to output the first alternating current to the primary side winding;
wherein a first end of the first wireless charging coil is connected to a first end of a secondary side winding of the isolation transformer, and the first wireless charging coil is configured to receive electrical power wirelessly transmitted by a second wireless charging coil;
wherein the first resonance compensation circuit is connected to a second end of the first wireless charging coil and a second end of the secondary side winding, and is configured to generate a resonance based on the electrical power received by the first wireless charging coil and/or the first alternating current received by the secondary side winding, and to output a first charging current to the rectifier circuit;
wherein the rectifier circuit is configured to rectify the first charging current and to output the rectified first charging current to an energy storage module; and
wherein the wireless charging circuit comprises a second wireless charging coil configured to wirelessly transmit electrical power to the first wireless charging coil in the multifunctional charging circuit.

14. The charging system according to claim 13, wherein the wireless charging circuit comprises a second resonance compensation circuit, and the design of the second resonance compensation circuit and the design of the first resonance compensation circuit in the multifunctional charging circuit are symmetrically arranged.

15. The charging system according to claim 14, wherein the wireless charging circuit further comprises a second inverter circuit;
the second inverter circuit is configured to convert a received second direct current into a second alternating current, and to output the second alternating current to the second resonance compensation circuit; and
the second resonance compensation circuit is connected to the second inverter circuit to generate a resonance based on the second alternating current and to output electrical power to the second wireless charging coil.

16. The charging system according to claim 13, wherein when the charging system is operated in a wireless charging mode, a phase of a voltage output by the rectifier circuit is 90° behind a phase of an induced voltage of the first wireless charging coil.

17. The charging system according to claim 13, wherein when the charging system is operated in a mixed charging mode, a phase of a voltage output by the rectifier circuit is 90° behind a phase of a voltage output by the first inverter circuit, and the phase of the voltage output by the rectifier circuit is 90° behind a phase of an induced voltage of the first wireless charging coil.

18. The charging system according to claim 13, wherein the rectifier circuit is further configured to convert the electrical power stored in the energy storage module into a third alternating current, and the first resonance compensation circuit is further configured to generate a resonance based on the third alternating current and to output a discharging current to the first wireless charging coil and/or the secondary side winding.

19. The charging system according to claim 18, wherein when the charging system is operated in a wired discharging mode, a phase of a voltage of the third alternating current output by the rectifier circuit is 90° ahead of a phase of a voltage of the primary side winding;
when the charging system is operated in a wireless discharging mode, the phase of the voltage of the third alternating current output by the rectifier circuit is 90° ahead of a phase of a voltage of the first wireless charging coil; and
when the charging system is operated in a mixed discharging mode, the phase of the voltage of the third alternating current output by the rectifier circuit is 90° ahead of the phase of the voltage of the primary side winding, and the phase of the voltage of the third alternating current output by the rectifier circuit is 90° ahead of the phase of the voltage of the first wireless charging coil.

20. The charging system according to claim 18, wherein when the charging system is operated in a wired charging mode, the second wireless charging coil is configured to stop the wireless transmission of electrical power; and/or when the charging system is operated in a wireless charging mode, the primary side winding is in a short-circuit state or the secondary side winding is in a short-circuit state.
